(19) United States
(12) Patent Application Publication
(10) Pub. No.: US 2009/0210274 A1
(43) Pub. Date: Aug. 20, 2009

(54) System and Method for Tracking and Managing Environmental Attributes

(76) Inventors: Shawn McMahon, North Larence, OH (US); John Ryan, Winter Haven, FL (US)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/371,784

(22) Filed: Feb. 16, 2009

Related U.S. Application Data
(60) Provisional application No. 61/028,604, filed on Feb. 14, 2008.
(60) Provisional application No. 61/042,798, filed on Apr. 7, 2008.

(51) Int. Cl. G06Q 30/00; G06Q 10/00; G06Q 50/00

(52) U.S. Cl. 705/7; 705/26

(57) ABSTRACT

A system and method for tracking and managing environmental attributes which provides a framework to facilitate the transparent listing, tracking, managing, and sale of environmental attributes. The system and method ensure greater transparency for buyers, sellers, and regulators and allow for the bundling and geographic referencing of environmental attributes.

### CROSS-REFERENCE TO RELATED APPLICATIONS

This application claims priority to U.S. provisional application No. 61/028,604, filed Feb. 14, 2008 and U.S. provisional application No. 61/042,798, filed Apr. 7, 2008, both of which are incorporated herein by reference

### BACKGROUND OF THE INVENTION

The present invention relates to a system and method for tracking and managing environmental attributes and provides a framework to facilitate the transparent listing, tracking, managing, and sale of environmental attributes. Environmental attributes and other attributes are features of air, water, and land that have a transactable economic value and can be sold or traded. As such, environmental attributes have economic value that can be separated from the underlying commodity or property. Examples of environmental attributes include, but are not limited to, carbon credits or offsets, priority emission credits or offsets, tradable renewable energy credits or offsets [TREC's], transfer of development rights, total maximum daily load credits or offsets [TMDL], renewable fuel standard credits or offsets, water credits or offsets, natural resource based credits or offsets such as threatened and endangered species credits or offsets, upland/wetland mitigation credits or offsets, and habitat mitigation credits or offsets. As is known in the art, credits represent activities that improve, in absolute terms, the related environmental attribute whereas offsets represent activities that reduce the forecasted or expected harm done to the related environmental attribute. For example, carbon credits may represent the sequestration of carbon dioxide which reduces the absolute amount of carbon dioxide in the atmosphere. Carbon offsets may represent a reduction in the amount of carbon dioxide emitted from a coal-fired electricity plant due to improved emissions control technology.

The method and system described herein addresses the tracking and transparency flaws currently present in many of the existing registries and exchanges through the application of specific policies and the creation of a unique listing and tracking software. Such software can be implemented at a variety of geographic areas, including, but not limited to, the municipal, county, provincial, state, or international levels. The software can also be implemented at other geographic areas, including, but not limited to, watersheds, development districts, or other user-defined areas. The system and method described herein can be implemented within an industry or industry group or among a plurality of industries or industry groups.

Recent years have seen rapid growth within the greenhouse gas (GHG) offset and renewable energy markets, largely due to the global increase in environmental awareness and in anticipation of government mandated offset requirements for polluters. To address this growing demand, private registries and exchanges have been developed to create forums for the listing and trading of environmental attributes. Environmental attributes are characteristics identified by an independent institution (such as registries or exchanges) that are biological, chemical, and/or mechanical in nature. The independent institution typically develops and adopts broadly accepted environmental standards for the measurement of characteristics of the environmental attributes and processes. An environmental attribute can also be a portion of property rights that can be segregated by legal means from the underlying property and creates the benefit of preserving the environmental characteristics of the property from alteration or destruction.

Environmental attributes can be segregated by the transfer of a portion of a property right from real property, the creation of an alternative technical process having less impact than a broadly accepted technical process, thus offsetting the impact of the original process by the creation of an “offset”, or the creation of a “credit” by a process that has the effect of neutralizing or reversing a negative environmental impact.

However, in their rush to provide these services, many existing exchanges and registries have overlooked many crucial elements that threaten the integrity of the environmental attributes. Specifically, many existing systems suffer from flaws in tracking and transparency, the application of generalized data that ignores regional differences (climate, soils, etc.), and lack of governmental oversight.

Additionally, in the current voluntary market, GHG offset and TREC providers are required to choose the standard (protocol) under which verification of these attributes is performed. Under the current systems, this standard is usually dictated by the registry or exchange on which the provider has chosen to list its credits. Though this allows the chosen registry/exchange to provide a level of assurance that the environmental attribute is consistent with their standard, it limits the marketability and exposure of the product/attribute. That is, current environmental attributes are often tied to a specific registry or exchange and cannot be traded or marketed outside the chosen registry or exchange.

### SUMMARY OF THE INVENTION

An object of the system and method described herein is to provide a method and system that allow for the transparent listing, tracking, managing, and sale of environmental attributes including, but not limited to, GHG credits and tradable renewable energy certificates (TREC's). The system and method allow for the creation of policies to incorporate transparency and traceability of environmental attributes, the application of regionally specific data (climate, soils, growth rate, etc.), and for governmental oversight at various levels, including, but not limited to, the municipal, county, provincial, state, and international levels. Additionally, the system and method permit the listing of environmental attributes verified under multiple offset standards or protocols.

The method and system described herein allow for the tracking and listing of environmental attributes which increases their credibility, transparency, and marketability. Using the system and method, buyers, sellers, regulators, and others can verify the source of an environmental attribute by tracing the attribute back to the underlying property. For instance, a potential purchaser of a carbon credit can use the system and method to verify the source and physical location of the carbon credit producer. The purchaser can accomplish this, for example, by using the GPS coordinates associated with the carbon credit to find the physical location of the producer of the environmental attribute. The purchaser can then be assured that the carbon credit is genuine and that the credit producer has in fact taken carbon control measures to reduce the amount of carbon emitted into the atmosphere. Similarly, the purchaser (or a government regulator) can trace the sale of the carbon credit to ensure that it has not been sold to multiple end-purchasers by an unscrupulous seller. Thus, purchasers, sellers, and regulators can be sure that only bona-fide environmental attributes are being sold or offered for sale.

The method and system described herein involve the collection, analysis, and application of local and regional data, the quantity and quality of the environmental attribute based on local and regional data, the integration of elements providing for oversight at the county and state level, and policies that permit a greater level of transparency than provided from existing systems within the current market.

The method and system further provide for the listing of environmental attributes under multiple existing, developing, and future standards (protocols). The multi-protocol environmental attributes created using the system and method can therefore be marketed widely on different registries or exchanges with differing protocols. Alternatively, the method and system allow for the creating of a single marketplace where buyers can purchase the environmental attributes that meet their specific needs while allowing sellers to increase their market exposure.

The method and system described herein allow for the bundling of environmental attributes from various sources to both meet the requirements of a given standard (protocol) and to increase the value of the environmental attributes sold. For instance, the system and method allow for the bundling of a carbon credit with a renewable energy credit to create a bundled environmental attribute. Such a bundled environmental attribute may be more valuable to the seller in the marketplace than the separate carbon and renewable energy credits. Such a bundled environmental attribute could compete, for example, with a solar energy credit since the latter has aspects of both a carbon credit and a renewable energy credit. Some buyers prefer to purchase single environmental attributes rather than a plurality of attributes and will therefore consider purchasing bundled environmental attributes as described above. Because of the increased number of willing buyers, such bundled environmental attributes may fetch higher prices than could be obtained by selling the constituent environmental attributes separately.

The system and method also allow for the convertibility of environmental attributes so they are compatible with multiple standards or protocols. Currently, many existing registries or exchanges have closed standards or protocols for the listing of environmental attributes. Thus, environmental attributes that conform to a particular protocol remain tied to the registry or exchange that implements that protocol. For example, an environmental attribute that is configured for listing on the California Climate Action Registry cannot be marketed to purchasers on the Chicago Climate Exchange. Using the system and method described herein, an existing environmental attribute can be adapted for use on a plurality of exchanges or registries, each of which may have a different protocol.

The system and method described herein also allow for the marketing and sales of environmental attributes to local, state-wide, national, and international markets, either through direct sales, contracts, or through brokers. The processes and policies of the system and method control the level and type of access to persons desiring to view, trade, or manage environmental attributes. The system and method also provide for the monitoring and control of environmental attributes before allowing them to be transferred to other market areas, registries, or exchanges. For instance, the system and method will not permit the private sale of an environmental attribute listed on the system without the creation and registration of a contract number, said contract number being maintained in the system for future reference and tracking purposes.

Geographically referenced data is introduced into the environmental attribute banking (EAB) system with every new environmental attribute listed by subscribers. As all environmental attributes and associated data provided by subscribers must first undergo third-party verification prior to registration into the system, the data will already have been vetted for accuracy. For instance, a third-party registry may have standards that ensure the accuracy of the environmental attribute data. The registry could, for example, verify the location, ownership, and operation of a carbon sequestration facility before allowing the facility to register a carbon credit with the registry.

Once registered into the EAB system, environmental attribute data is segregated into the appropriate geographical subsets, to be used in the analysis and validation of future environmental attributes. Every additional environmental attribute listed on the EAB from a given geographical subset will improve the accuracy of the analysis used for future validations, thereby creating highly accurate localized data.

The localized data also conforms the metrics for the environmental attributes to localized standards of measurement. Metrics include standard units of measurement (such as the metric system or customary system of measurements) and localized methods of calculation and formulation for both seller and buyer. The method and system allow metrics to be converted between the chosen standards of the buyer and seller, thus providing the user with interfaces for automated conversion of metrics between different localities that conform to local standards. This function occurs automatically within the system, and limits the amount of additional information needed by the user to convert their data.

The localized data includes authorized access parameters which limit EAB users to specific areas of the EAB. For instance, buyers of carbon credits can be limited to areas of the EAB system that list carbon credits. Users requiring more comprehensive information, such as analysts or regulators, may be given full access to the EAB system in order to monitor system activities and detect or prevent any irregularities.

Existing systems typically provide little transactional certainty from the creation of the saleable environmental attribute to its listing on an exchange to a final sale to a buyer. This lack of transactional certainty or traceability casts doubt on the integrity and reliability of the environmental attribute and impedes trust in the marketplace. This lack of transparency has been the foundation for warranted concerns as to the double sales of environmental attributes, the sources of the environmental attributes being sold, and the underlying nature of the creation of the environmental attributes. For instance, buyers rightly worry that an environmental attribute might be sold multiple times by an unscrupulous seller if there is no way to track the sales and ownership of a particular environmental attribute. Buyers also worry about purchasing fraudulent environmental attributes where there is no underlying physical reality to the attribute (e.g., if a seller creates a fraudulent carbon credit based on a fictitious carbon sequestration plant.)

To address these issues, all actions on the EAB system are associated with a transactional record that can be sourced (traced) from the creation of an environmental attribute through its sale, including the location where said environmental attribute was created. Every environmental attribute includes a geographical reference (latitude/longitude) that is tied to an internal global information system (GIS), accessible to sellers, buyers, regulators, and auditors. This additional level of transparency provides further assurances that an environmental attribute is genuine and has not been applied, sold, or counted more than once. The tracking of environmental attributes from creation through purchase and, after the attribute is used or expired, retirement of the environmental attribute, is a key feature of the system and method disclosed herein.

The creation of this transactional transparency and scientifically supportable system, with a focus on local and regional aspects, creates a tool where governmental and private institutions can track the reduction and absorption of greenhouse gas emissions as well as other environmental attributes through a market based approach. This allows both buyer and seller to receive economic benefits for compliance with regulation through non-regulatory means and the sale of voluntary environmental attributes as well.

Buyers and sellers may execute transactions on the EAB system via a standard contract for sale. Alternatively, buyers and sellers may execute private contracts or contracts on a third-party exchange or registry, although the environmental attribute is not considered sold until a contract registration number is issued and contract execution documentation is filed with the EAB system.

### BRIEF DESCRIPTION OF THE DRAWINGS

FIG. 1 is a diagram of a system in one embodiment of the invention.

FIG. 2 is a flow chart illustrating the method in one embodiment.

### DETAILED DESCRIPTION

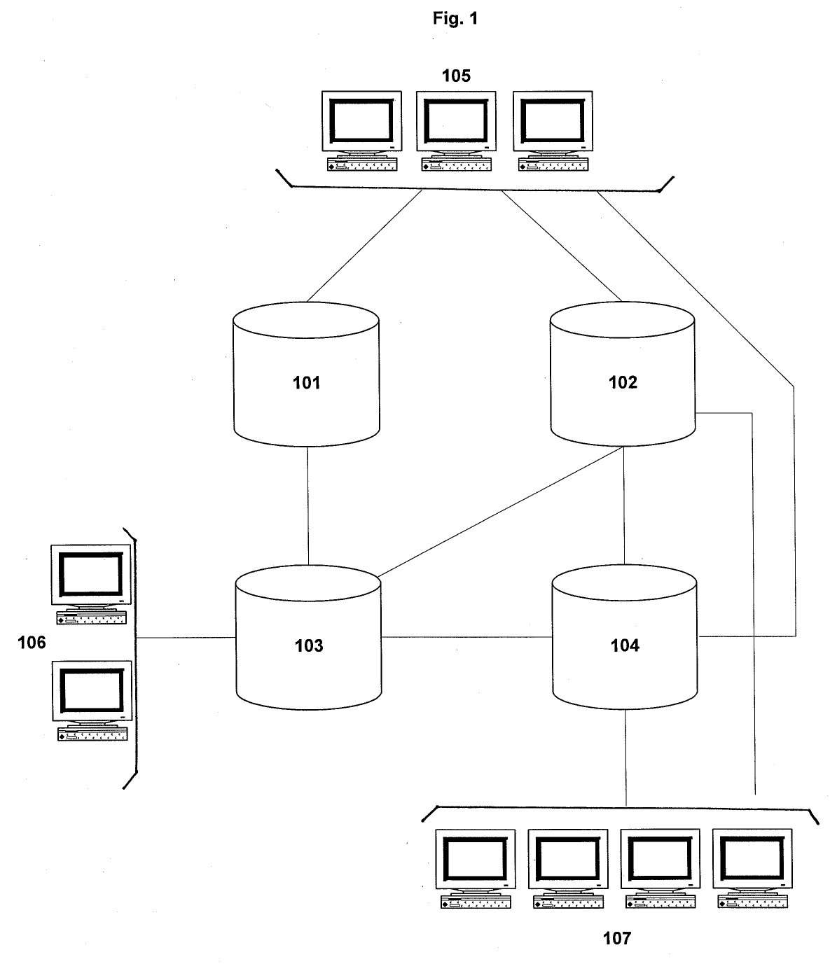

FIG. 1 is a diagram of a system in one embodiment of the invention.

Registration database 101 is a database where authorized sellers 105 can upload data representative of their environmental attributes. Sellers 105 can upload documents related to their environmental attributes to document imaging server 102.

Third-party verifiers 106 have access to verification database 103. As described in more detail below, verifiers 106 will verify the environmental attributes and certify their compliance with certain protocols and standards.

Attributes are moved to live transaction database 104 after they have been registered and verified by a third-party verifier 106. As described more fully below, authorized sellers 105 and registered buyers 107 can access the live transaction database 104 to view, buy, and sell attributes.

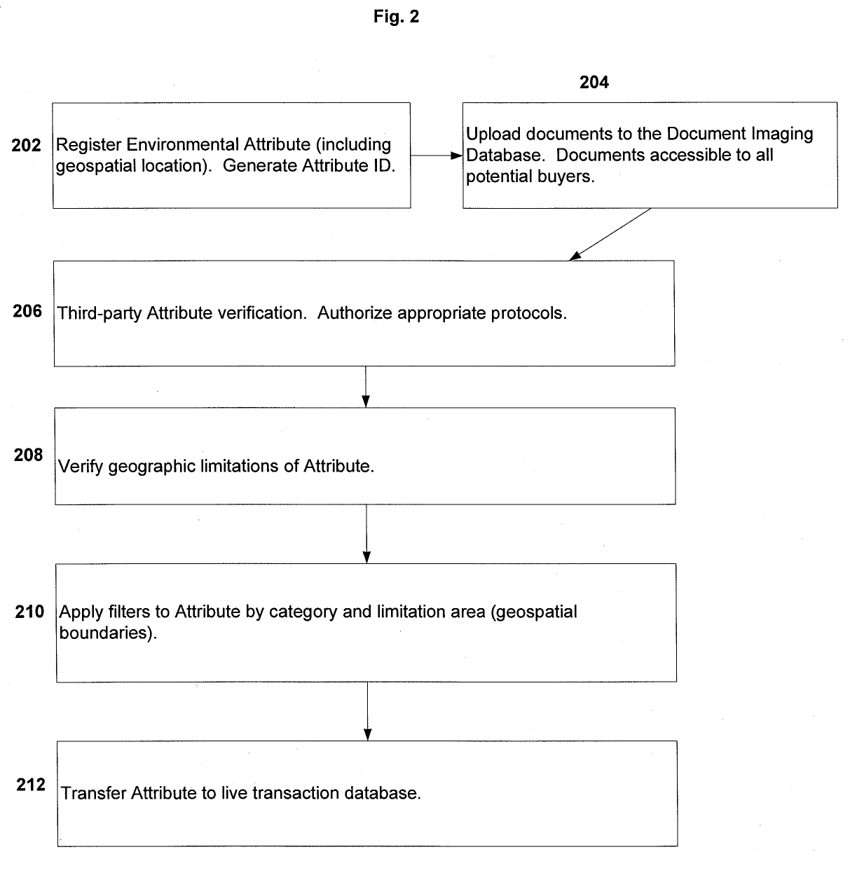

FIG. 2 is a flow diagram illustrating the system and method in one embodiment.

At step 202, an authorized seller 105 registers a credit or other environmental attribute for qualification and places it in a reserve pool located on the registration database 101. The reserve pool holds the attribute until it has been “qualified” or verified for authenticity, ownership, regulatory compliance, and other factors by third-party verifier 106.

During registration, the system generates an attribute ID. This unique ID can be subsequently used to track the flow of the attribute through the system, including generation, registration, verification, listing, sale, and expiration. After sale, the attribute ID will be replaced by a unique contract number which documents the sale.

The system also registers the geospatial location of the environmental attribute. This will allow subsequent purchasers, regulators, and others to locate the underlying physical location associated with the attribute. For instance, for a carbon credit associated with a given carbon sequestration plant, the system would record the latitude and longitude of the plant. This would allow subsequent purchasers, regulators, and others to verify the physical location of the plant and trace the credit from its production to its end-use.

The recordation of geospatial coordinates also allows end-users to determine if they are eligible to consume the attribute. For instance, pursuant to United States law, carbon credits produced in the U.S. might only be eligible for use (consumption) by residents of the U.S. The recordation of the geospatial coordinates associated with a particular carbon credit will allow potential customers to determine if they are eligible to consume the credit.

At step 204, the seller 105 uploads various documents to the document imaging server 102. Such documents include, but are not limited to, instruments illustrating ownership of the environmental attribute such as deeds, easements, underlying contracts, or regulatory compliance documents. These documents must be uploaded to the imaging server 102 before the system will permit the attribute to be placed in reserve.

After the attribute is released for trading, potential buyers 107 are able to access the documents on the imaging server 102 that relate to the listed environmental attribute. Buyers can access such data using the environmental attribute's attribute ID (credit ID). After an attribute is sold pursuant to a contract, a contract number (contract ID) is created and buyers 107 can subsequently access the related documents using the contract number.

The availability of documents on the document imaging server 102 gives potential buyers 107 assurance of the authenticity of environmental attributes that are listed on the system. For instance, a potential buyer 107 can view the legal instrument that created a particular attribute or the regulatory compliance documents associated with the attribute. These documents ensure the transparency of attributes listed on the system and give the buyer 107 added assurances that the attributes are not fraudulent and have not been sold multiple times or consumed. Authorized regulatory authorities can also access the documents on the imaging server 102 to ensure appropriate regulatory compliance and to prevent fraud and abuse.

At step 206, the environmental attribute is transferred out of the reserve pool on the registration database 101 into a static verification database 103. Authorized third-party verifiers 106 can access the verification database 103. An attribute verifier 106 will verify the authenticity of a given attribute and certify that the attribute is valid. The verifier 106 uses the documents contained in the document imaging server 102 to perform this verification task. The verifier 106 can also modify quantity and parameter information for the attribute, as needed. These modifications must be approved by the seller 105.

No live transactions are permitted for an attribute that is stored on the verification database 103. All attributes must have verifier authorization data visible before transactions are permitted. Documents necessary for attribute verification must be uploaded to the document imaging database 102 before the third-party attribute verifier 106 can verify the attribute.

The verifier 106 also declares the authorized protocols under which the attribute can be generated based on information provided by the owner of the attribute and methodologies established by the accrediting institution. Accrediting institutions are third-party groups that establish protocols and standards for environmental attributes. The verifier 106 will ensure the integrity of the data associated with the attribute and ensure that the data complies with the selected protocols. For instance, the verifier 106 can ensure that the attribute complies with location specific data such as soil type, species type, technology type, or development right characteristics.

The verifier 106 can also bundle a plurality of attributes together to create a bundled attribute. For instance, a verifier 106 could, subject to the owner's permission, bundle a carbon credit with a renewable energy credit to create a bundled environmental attribute. Such a bundled attribute could then compete in the marketplace with other attributes (such as a solar energy credit) that have carbon reduction and renewable energy aspects.

An authorized verifier 106 can post qualified attributes from an (outside) non-authorized verifier if the authorized verifier 106 can provide all relevant documents from the non-authorized verifier. In addition, the outside verifier must be able to represent their certification in the selected protocol and methodologies. The authorized verifier 106 must also certify the truthfulness of the information presented by the outside verifier.

All parameters are subject to review by a team of reviewers, scientists, technicians, and/or analysts for accuracy, qualification and transactional chain-of-custody. The data required for sale is dependant upon the protocols and methodologies used to approve the attribute for sale. That is, each environmental attribute must have sufficient data to comply with the protocol under which it is to be listed or sold.

In order to provide full transactional transparency, no attribute will be considered transferred to a new owner without the inclusion of a unique contract number or numbers created from the attribute ID. Said contract number will be recorded to ensure the tracking of the attribute from seller 105 to purchaser 107.

Attribute purchasers 107 must register their contact information with the system before they will be allowed to purchase an attribute or register a sale. This ensures the transparency of transactions on the system and facilitates the tracking of environmental attributes. For all sales that occur directly on the system, a unique contract number will be automatically generated and associated with the sale. For all private sales that occur off of the system, the buyer and seller must register the sale with the system. The system will then generate a contract number and associate the attribute with the contract number. In effect, this recordation of the contract number represents the equivalent of the transfer of title to the attribute from seller to buyer.

Any purchaser 107 of an attribute can be identified as a user qualified to consume the attribute or alternatively a member of the transactional chain-of-custody between generator of an attribute and consumer of the attribute. This allows for the complete tracing of environmental attributes from generation to eventual consumption (or expiration), including all events in between such as verification, listing, and sale.

For all documents that separate characteristics of an attribute into attribute categories under multiple protocols for sale or where a single attribute can be sold under multiple protocols, the attribute ID or the ensuing contract number maintains a unique identifier so that the attribute may not be sold in more than one protocol upon execution of the transaction for each attribute created.

Upon approval by a receiving protocol accrediting institution, protocols may be accepted from other protocol accrediting institutions. Algorithms and conversion methodologies allow both suppliers and purchasers to convert among protocols. Such conversions include currency conversions and conversions among different units of measurement such as metric and English units of measurement.

At step 208, the system verifies any geographic limitations placed on the environmental attribute. For attributes that contain geographic limitations, the system verifies that the geospatial coordinates of the attribute lie within the set geographic boundary. For instance, if an attribute is limited to the United States, then the system will verify that the latitude and longitude associated with the attribute fall within the territory of the United States.

Buyers may purchase any environmental attribute regardless of its geographic limitations. However, buyers may only “apply” or consume a geographically limited attribute if the buyer's location lies within the limitation area. For instance, a purchaser in France would be permitted to purchase an environmental attribute that is geographically limited to the United States. However, the French purchaser could not apply or consume the attribute.

At step 210, the system applies filters to represent the applicable attribute category. The system also filters by limitation areas (geospatial boundaries).

At step 212, the attribute is transferred out of the verification database 103 and into the live transaction database 104. Once in the transaction database 104, potential purchasers 107 and others can view and purchase the environmental attribute.

Sellers 105 can place ask prices for their attributes and buyers 107 can place bid prices. Ask and bid prices can be viewed by all registered users within the category of attributes for sale.

Upon sale, only the purchaser 107 and seller 105 can see the final agreed-upon price. The system will record the sales price but will not display it to users other than the actual purchaser and seller or the appropriate regulatory authorities. A general statistical sample of prices may be available to general users to permit them to determine the general price level of the market.

As described above, no sale is permitted without the generation and registration of a unique contract number. The contract number allows for the tracking of the environmental attribute and to prevent unauthorized or duplicate sales.

Sales of attributes to outside exchanges, registries, or brokers are permitted. Attributes subject to such sales are represented as “unused” until the attribute is acquired by an end-user, at which time the attribute will be represented as “expired” or “held for expiration”, depending upon the end-user's intended use. The system will not permit attributes that are represented as “expired” or “held for expiration” to be sold or listed for sale.

An attribute that was “held for expiration” may be re-sold if the accrediting protocol permits such a re-sale. Prior to listing, however, such an attribute must be re-verified, including verification that the attribute was not used and has not expired. In any subsequent sale, the original contract number will be recorded as a component of the sale.

Accordingly, while the invention has been described with reference to the structures and processes disclosed, it is not confined to the details set forth, but is intended to cover such modifications or changes as may fall within the scope of the following claims.

What is claimed is:

1. A method for the transparent listing of environmental attributes for sale comprising the steps of:
a) transferring to a database data representative of an environmental attribute;
b) generating a unique attribute identification number for said attribute;
c) associating said identification number with said attribute;
d) transferring at least one document related to said attribute to said database;
e) verifying said attribute data for completeness and correctness;
f) ensuring that said attribute is available for sale based on said identification number; and
g) listing said attribute for sale.

2. The method of claim 1 further comprising the steps of:
a) purchasing said attribute for an agreed-upon price;
b) generating a unique contract number associated with said sale; and
c) associating said contract number with said attribute.

3. The method of claim 2 wherein said at least one document is selected from the group consisting of deed, easement, underlying contract, or regulatory compliance document.

4. The method of claim 2 wherein said verifying step further comprises:
a) verifying that said attribute data complies with a first protocol;
b) verifying that said attribute data contains geospatial data; and
c) verifying that said geospatial data is located within an appropriate territorial boundary.

5. The method of claim 2 wherein said listing step further comprises:
a) bundling said attribute with a second environmental attribute to create a composite attribute; and
b) listing said composite attribute for sale.

6. A system for the transparent listing of environmental attributes for sale comprising:
a) a first database wherein a seller can transfer data representative of an environmental attribute;
b) a second database wherein a seller can transfer at least one document related to said attribute;
c) a third database wherein a verifier can verify said attribute for completeness and correctness; and
d) a fourth database for listing said attribute for sale.

7. A system for the transparent listing of environmental attributes for sale comprising:
a) a first module for receiving data representative of an environmental attribute;
b) a second module for generating a unique attribute identification number for said attribute;
c) a third module for associating said identification number with said attribute;
d) a fourth module for verifying said attribute data for completeness and correctness;
e) a fifth module for ensuring that said attribute is available for sale based on said identification number; and
f) a sixth module for listing said attribute for sale.
